(19) United States
(12) Patent Application Publication
(10) Pub. No.: US 2002/0152573 A1
(43) Pub. Date: Oct. 24, 2002

(54) Wiper apparatus and car rear wiper

(76) Inventors: Michio Tsukui, Takasaki-shi (JP); Junichi Saito, Kiryu-shi (JP); Hiroki Kuroiwa, Nitta-gun (JP); Kouji Kobayashi, Nitta-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/121,665

(22) Filed: Apr. 15, 2002

(30) Foreign Application Priority Data
Apr. 23, 2001 (JP) 2001-124903
Oct. 31, 2001 (JP) 2001-335336

(51) Int. Cl. B60S 1/06

(52) U.S. Cl. 15/250.3; 15/250.351; 15/250.001

(57) ABSTRACT

A wiper blade 4 is movably arranged along a glass surface 3. Piezoelectric elements 6a and 6b comprise a piezoelectric ceramic and apply vibration to the wiper blade 4. Owing to this vibration, the wiper blade 4 moves by itself on the glass surface 3. The piezoelectric elements 6a and 6b are provided on the wiper blade 4, its tip, etc. Since the wiper blade 4 moves by itself, there is no need for an electromagnetic motor or a link mechanism to drive the wiper blade. It is possible to provide a small and light-weight wiper apparatus or improve the layout. Accordingly, the wiper apparatus can be mounted on a narrow and small place such as a glass hatch or a convertible's rear window.

### BACKGROUND OF THE INVENTION

1. Field of the Invention

The present invention relates to a wiper apparatus used for cars, outdoor surveillance cameras, etc. Specifically, the present invention concerns a wiper apparatus attached to a narrow space such as a CCD camera or a rear wiper which makes it difficult to arrange a motor or a link mechanism for driving a wiper blade.

2. Related Art Statement

In recent years, the general consciousness of environmental conservation shifts from expansion to infiltration. In the field of cars, for example, one asked-for solution is weight saving of a car body. Electrical components including a wiper system are also subject to this trend, and the weight saving is promoted for various parts such as a wiper blade, a motor, etc.

As far as the car design is concerned, the wiper shape may be a critical factor in esthetic effects of the car appearance. The design may be considerably depend on which position to mount a wiper blade on the front or rear of the car. Accordingly, capability of arranging the wiper apparatus at any position improves the degree of freedom of the car design and enhances competitiveness in the design.

A conventional wiper system uses an electromagnetic motor as a drive unit and uses a link mechanism to implement the wiping function. However, the use of the motor or the link mechanism makes it impossible to expect an innovatively small and light system from the viewpoint of technological maturity. Mechanically, the conventional wiper system limits the degree of freedom of selecting positions to mount the wiper blade. This is a serious restriction on the design and its improvement has been long awaited.

Especially, a car rear wiper is accompanied by the following problems. First, the rear wiper is generally configured so that a wiper shaft is provided under a rear window and the wiper blade swings therearound. However, mounting a motor in the trunk decreases the trunk capacity for the motor. Second, in the case of a car having a glass hatch, mounting a rear wiper motor on the hatch makes the hatch heavy and hinders the rear view. By contrast, when the motor is mounted on the car body, the wiper blade needs to be separately arranged on the hatch for opening and closing the hatch. In addition, the motor and the wiper blade need to be detachable when the hatch is opened or closed, complicating the structure. Third, the wiper motor cannot be mounted on a convertible. The rear wiper itself cannot be mounted. Fourth, the rear wiper implements reciprocal movement of the wiper blade solely by means of motor's forward and reverse revolution. Accordingly, a forward reverse circuit or a relay plate is needed, complicating the circuit configuration or other configurations near the motor.

Recently, special attention is paid to various controls based on the video recognition using a CCD camera for ensuring safe and comfortable driving. Actually, cameras have been mounted on various parts of a car. A raindrop or dust adhered to the camera front may obstruct the field of vision and hinder the image recognition. It is desirable to supply the camera with a wiper system, i.e., an apparatus to remove raindrops, etc. Under the present conditions, however, there is not provided a microminiature wiper system capable of being mounted on the CCD camera. Its development has been long awaited.

Apart from the field of cars, many surveillance cameras are installed outdoors and are accompanied by the same problems regarding the field of vision ahead thereof. Some surveillance cameras are equipped with the wiper system using an electromagnetic motor. However, such system requires a large-scale mechanism and is not applicable to a small surveillance camera.

### SUMMARY OF THE INVENTION

It is an object of the present invention to provide a small and light-weight wiper apparatus without the need for an electromagnetic motor or a link mechanism. It is another object of the present invention to provide a small and light-weight car rear wiper capable of being mounted on a glass hatch or a convertible.

In order to achieve the above-mentioned objects, a wiper apparatus according to the present invention comprises: a wiper blade which is mounted on a wipe surface and is movably provided along the wipe surface; and a vibration means which provides the wiper blade with vibration for driving the wiper blade on the wipe surface.

According to the present invention, the vibration means applies vibration to the wiper blade, making it possible to move the wiper blade by itself on the wipe surface. This eliminates the need for an electromagnetic motor or a link mechanism to drive the wiper blade, enabling the wiper apparatus to be small and light-weight. Since a position to mount the wiper blade is not restricted by a motor or a link, the apparatus layout can be improved. The wiper apparatus can be mounted on a narrow and small place. Accordingly, the wiper apparatus can be attached to, e.g., a vehicle-mounted CCD camera where no wiper apparatus has been equipped due to a limited mounting area.

In the wiper apparatus, the vibration means may be provided on the wiper blade, e.g., on the top or side surface of the wiper blade. For example, the vibration means may be molded with the wiper blade to be provided inside the wiper blade. Further, it may be preferable to configure the wiper apparatus by serially connecting a plurality of wiper blades provided with vibration means.

One end of the wiper blade may be fixed to a rotating shaft so that the wiper blade can be swingably provided on the wipe surface. The vibration means may be provided on the other end of the wiper blade or near the rotating shaft. Alternatively, it may be preferable to provide a plurality of vibration means at a specified interval on the wiper blade.

The wiper blade may be moved along a guide member provided on the wipe surface. The vibration means may apply vibration to the guide member to drive the wiper blade. The vibration means may be positioned where it can apply vibration to the guide member. It is also possible to position the vibration means not only at the end of the guide member or the inside thereof, but also at a position distant from the guide member via a vibration transmission means.

A wiper apparatus according to the present invention drives a wiper blade provided on a wipe surface along the wipe surface; wherein the wiper blade comprises a vibration means; and the vibration means generates vibration to allow the wiper blade to move by itself on the wipe surface.

According to the present invention, the vibration means configures the wiper blade itself, simplifying the apparatus configuration and decreasing the apparatus weight. Also in this case, the configuration eliminates the need for the electromagnetic motor or the link mechanism for driving the wiper blade, enabling the wiper apparatus to be small and light-weight and improving the layout.

The vibration means may be comprise a piezoelectric element. For example, it is possible to use bimorph piezoelectric ceramics for the vibration means. The piezoelectric element may be supplied with voltage having a sinusoidal waveform. By applying a sinusoidal-waveform voltage, the vibration means generates elliptical vibration in a drive support section formed on a contact section between the wiper blade and the wipe surface. The elliptical vibration allows the wiper blade to move on the wipe surface.

The piezoelectric element may be supplied with voltage having a sawtooth waveform. The sawtooth voltage causes a difference in deformation speeds of the piezoelectric element. The deformation speed difference causes a difference in inertia forces acting on the wiper blade. A displacement amount for a slow change in the sawtooth voltage becomes greater than a displacement amount for a rapid change in that voltage. The wiper blade moves to the side with a greater displacement amount. Applying a sawtooth waveform voltage is suitable when the wiper blade is provided with one vibration means or comprises the vibration means.

On the other hand, a car rear wiper according to the present invention comprises: a wiper blade which is arranged on a car rear window and is swingably provided on the rear window with one end fixed to a rotating shaft; and a piezoelectric element which is attached to the wiper blade and applies reciprocal vibration to the wiper blade along its movement direction.

According to the present invention, a piezoelectric element is used to supply the wiper blade arranged on a rear window with reciprocal vibration along the movement direction. Thus, the wiper blade can move by itself on the rear window. The configuration eliminates the need for the electromagnetic motor or the link mechanism for driving the wiper blade, enabling the wiper apparatus to be small and light-weight. Since a position to mount the wiper blade is not restricted by a motor or a link, the apparatus layout can be improved.

In this case, it is possible to arrange the entire wiper apparatus body including the wiper blade, the piezoelectric element, etc. on the rear window. It is just necessary to arrange a lead wire and a driver in the body. In addition, the lead wire can be replaced by printed wiring capable of glass wiring on the rear window. Accordingly, the wiper apparatus can be mounted on a narrow and small place. For example, the rear wiper can be mounted on a hatchback car's glass hatch or a convertible's rear window.

The rear wiper can be freely controlled for an intermittent operation, variable speed, reverse operation etc. by changing the voltage input waveform. Accordingly, a forward reverse circuit, a relay plate, etc. are unneeded, simplifying the circuit configuration or other configurations near the motor.

In the car rear wiper, the piezoelectric element may be supplied with voltage having a sawtooth waveform. The sawtooth voltage causes a difference in deformation speeds of the piezoelectric element. The deformation speed difference causes a difference in inertia forces acting on the wiper blade. A displacement amount for a slow change in the sawtooth voltage becomes greater than a displacement amount for a rapid change in that voltage. The wiper blade moves to the side with a greater displacement amount.

In the car rear wiper, it may be preferable to further provide the rotating shaft with a resistance provision means for providing the rotating shaft with rotational resistance. It may be preferable to connect a plurality of the piezoelectric elements in series to the wiper blade. The other end of the wiper blade may be tipped with the piezoelectric element.

A car rear wiper according to the present invention can be also configured to comprise: a guide rail provided along an edge of a car rear window; a wiper blade which is attached to the guide rail and is movable along the guide rail; and a piezoelectric element which is attached to the guide rail and supplies the wiper blade with reciprocal vibration along its movement direction via the guide rail.

The above-described and other objects, and novel feature of the present invention will become apparent more fully from the description of the following specification in conjunction with the accompanying drawings.

### BRIEF DESCRIPTION OF THE DRAWINGS

FIG. 1 is a perspective view showing a configuration of a wiper apparatus as embodiment 1 of the present invention;

FIG. 2 is an explanatory diagram showing a configuration of a wiper blade used for the wiper apparatus in FIG. 1;

FIG. 3 is a side view of the wiper blade in FIG. 2;

FIG. 4 is an explanatory diagram showing a configuration of a member vibration model using piezoelectric ceramic;

FIG. 5 is an explanatory diagram showing vibration forms of the model in FIG. 4, wherein FIG. 5A shows a vibration form on the XY plane and FIG. 5B that on the XZ plane;

FIG. 6 is an explanatory diagram showing displacement at the tip of the model;

FIG. 7 is an explanatory diagram showing a vibration state at the tip of the model;

FIG. 8 is an explanatory diagram showing a configuration of a wiper apparatus as embodiment 2 of the present invention;

FIG. 9 is an explanatory diagram showing a configuration of a laminated piezoelectric ceramic;

FIG. 10 is an explanatory diagram showing a configuration of a modification example of arranging the piezoelectric element near a rotating shaft so that the piezoelectric element expands and contracts in a direction orthogonal to an extension direction of a blade;

FIG. 11 is an explanatory diagram showing a configuration of a modification example of arranging the piezoelectric element near the rotating shaft so that the piezoelectric element expands and contracts in a direction parallel to an extension direction of the blade;

FIG. 12 is an explanatory diagram showing a configuration of a wiper apparatus as embodiment 3 of the present invention;

FIG. 13 is an explanatory diagram showing a configuration of a wiper apparatus as embodiment 4 of the present invention;

FIG. 14 is an explanatory diagram showing a general form of a bimorph piezoelectric element;

FIG. 15 is an explanatory diagram showing an operation of an operation confirmation model with the bimorph piezoelectric element base fixed;

FIG. 16 is an explanatory diagram showing behavior of the piezoelectric element when a sawtooth voltage is applied to the model in FIG. 15;

FIG. 17 is an explanatory diagram showing a waveform of voltage actually applied to the wiper apparatus;

FIG. 18 is an explanatory diagram showing behavior of the blade when the voltage in FIG. 17 is applied;

FIG. 19 is an explanatory diagram showing a modification example of arranging the blade on the wiper apparatus;

FIG. 20 is an explanatory diagram showing a state of attaching a rear wiper as embodiment 5 of the present invention;

FIG. 21A, 21B is an explanatory diagram showing a configuration of the rear wiper in FIG. 20;

FIG. 22 is a perspective view showing the rear wiper in FIG. 21A, 21B mounted on a glass hatch of a hatchback car;

FIG. 23 is a perspective view showing the rear wiper in FIG. 21A, 21B mounted on a convertible's rear window;

FIG. 24 is an explanatory diagram showing a modification example of arranging the piezoelectric element for the rear wiper in FIG. 21A, 21B;

FIG. 25 is an explanatory diagram another modification example of arranging the piezoelectric element for the rear wiper in FIG. 21A, 21B;

FIG. 26 is an explanatory diagram showing a state of attaching a rear wiper as embodiment 6 of the present invention; and

FIG. 27 is an explanatory diagram showing a state of attaching a rear wiper as embodiment 7 of the present invention.

### DESCRIPTION OF THE PREFERRED EMBODIMENT

Embodiments of the present invention will be described in further detail with reference to the accompanying drawings.

(Embodiment 1)

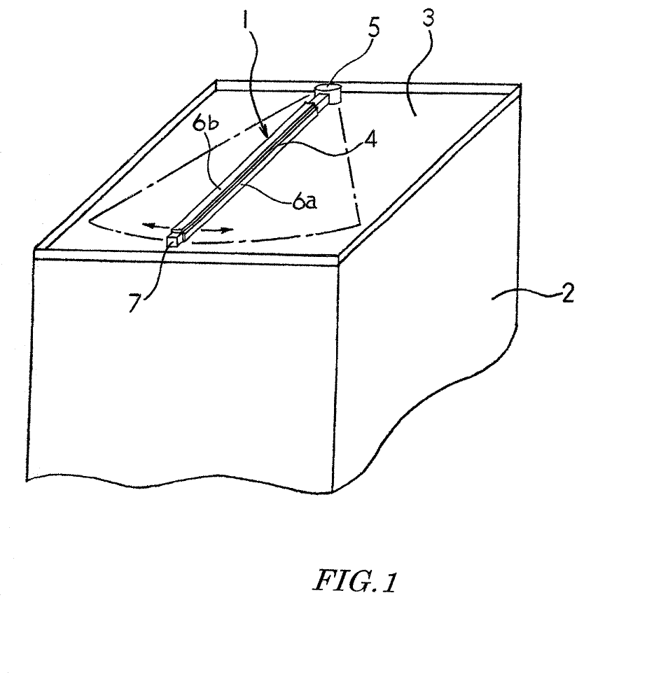

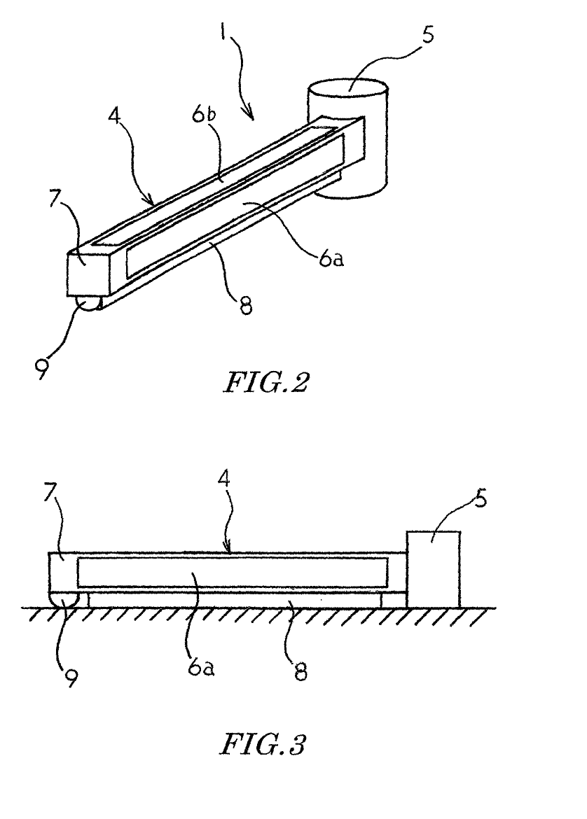

FIG. 1 is a perspective view showing a configuration of a wiper apparatus as embodiment 1 of the present invention. FIG. 2 is an explanatory diagram showing a configuration of a wiper blade used for the wiper apparatus in FIG. 1. FIG. 3 is a side view of the wiper blade in FIG. 2.

A wiper apparatus 1 according to the embodiment is a wiper apparatus mounted on a CCD camera used for a car's rear monitor, a side monitor arranged on the side of a front bumper, etc. As shown in FIG. 1, the wiper apparatus 1 is mounted on a glass surface (wipe surface) 3 in front of a CCD camera body 2. The wiper apparatus 1 comprises a wiper blade (hereafter abbreviated as a blade) 4 and a rotating shaft 5 for supporting the blade 4. Piezoelectric elements (vibration means) 6a and 6b are mounted on the blade 4 and generate vibration to move the blade 4 by itself on the glass surface 3.

As shown in FIG. 2, the blade 4 comprises an arm 7, piezoelectric elements 6a and 6b mounted on side and top surfaces of the arm 7, wipe rubber 8, and a drive support section 9. The arm 7 is a metal quadratic prism approximately 20 mm long and its end is fixed to the rotating shaft 5. The rotating shaft 5 contains a bearing and can freely rotate on the glass surface 3. The blade 4 is freely swingably supported around the rotating shaft 5 under a constant pressure for wiping. The blade 4 can freely move within a range presented by dash-dot lines.

The wipe rubber 8 is a rubber member mounted on the bottom surface of the arm 7. The bottom edge of the wipe rubber 8 touches the glass surface 3. The wipe rubber 8 slidingly moves on the glass surface 3 in accordance with an operation of the blade 4 to wipe drops of water or dust from the glass surface 3. The drive support section 9 is made of a steel ball and is attached to the bottom surface of the arm 7 at its tip. The bottom end of the drive support section 9 makes a point contact with the glass surface 3 and generates elliptical vibration due to vibration of the piezoelectric elements 6a and 6b to be described later.

The piezoelectric elements 6a and 6b comprise plate-shaped piezoelectric ceramics and are directly stuck on the side and top surfaces of the arm 7. FIG. 2 illustrates the piezoelectric elements 6a and 6b by omitting their thickness. Voltages with different phases are applied to the piezoelectric elements 6a and 6b to generate elliptical vibration at the drive support section 9. This elliptical vibration allows the blade 4 to move by itself on the glass surface 3. The following describes the principle of elliptical vibration at the drive support section 9 by using a model.

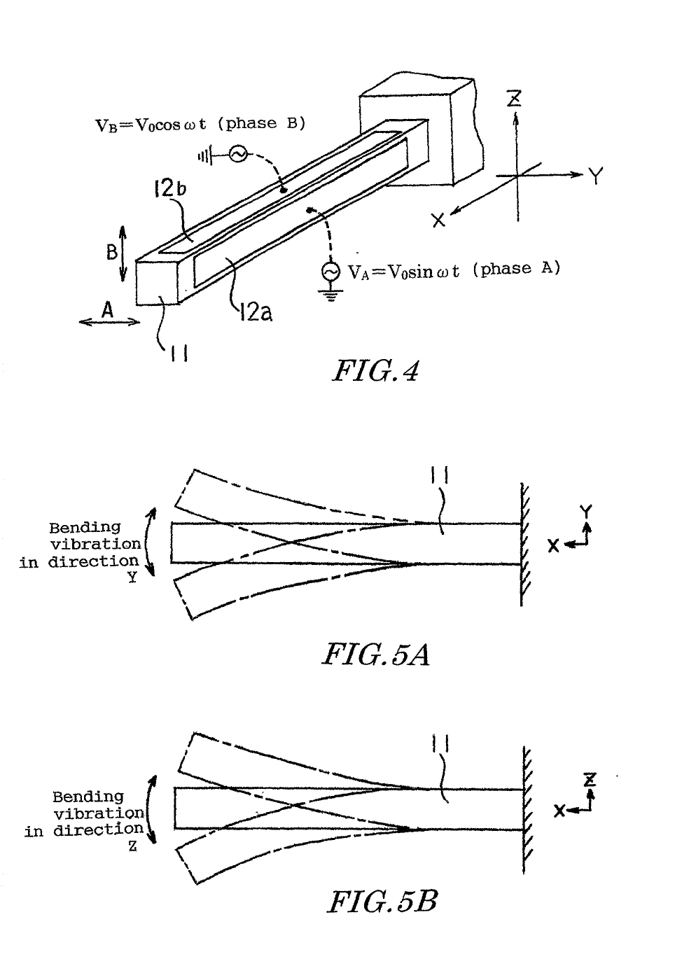

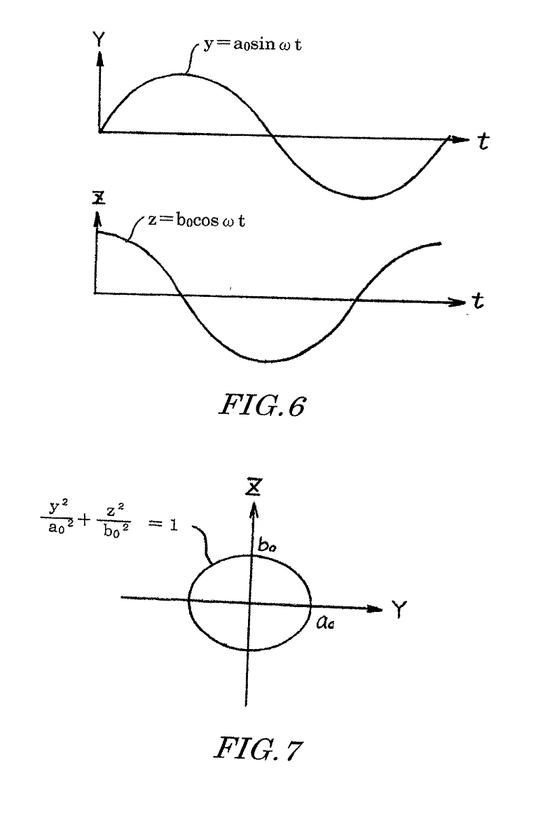

FIG. 4 is an explanatory diagram showing a configuration of a member vibration model using piezoelectric ceramic. FIG. 5 is an explanatory diagram showing vibration forms of the model in FIG. 4, wherein FIG. 5A shows a vibration form on the XY plane and FIG. 5B that on the XZ plane. FIG. 6 is an explanatory diagram showing displacement at the tip of the model. FIG. 7 is an explanatory diagram showing a vibration state at the tip of the model.

According to the model in FIG. 4, piezoelectric elements 12a and 12b are mounted on side and top surfaces of a quadratic prismatic metal strip 11. The piezoelectric element 12a is used for mode A so that the metal strip 11 generates vibration in the direction along the XY plane, i.e., vibration in direction A in FIG. 4. The piezoelectric element 12b is used for mode B so that the metal strip 11 generates vibration in the direction along the XZ plane, i.e., vibration in direction B in FIG. 4. As shown in FIG. 5A, 5B, applying voltage to the piezoelectric element 12a causes bending vibration to the metal strip 11 in direction Y on the XY plane. Applying voltage to the piezoelectric element 12b causes bending vibration to the metal strip 11 in direction Z on the XZ plane.

The piezoelectric elements 12a and 12b are supplied with voltages VA=V₀ sin ωt (phase A) and VB=V₀ cos ωt (phase B), respectively. There is a deviation by a quarter cycle between these phases. A displacement of metal strip 11 depends on voltage. As shown in FIG. 6, displacements of the metal strip 11 in directions Y and Z can be expressed as y=a₀ sin ωt and z=b₀ cos ωt, respectively. Namely, the metal strip 11 is subject to bending vibration in direction Y due to the piezoelectric element 12a and bending vibration in direction Z due to the piezoelectric element 12b with a deviation of a quarter cycle. The displacements indirections Y and Z vibrate the metal strip 11. The locus is formed by combining the displacements in both directions. The displacements in directions Y and Z, i.e., y=a₀ sin ωt and z=b₀ cos ωt, derive the relationship represented by the following equations.

y²=a₀² sin ²ωt

z²=b₀² cos ²ωt (1)

y²/a₀²+z²/b₀²=1 (2)

Equation (2) signifies an ellipse having the major or minor axis equal to a₀ or b₀. Accordingly, it is found that the metal strip 11 vibrates by forming an elliptical locus as shown in FIG. 7. When voltages of VA=V₀ sin ωt and VB=V₀ cos ωt are applied to the piezoelectric elements 6a and 6b as shown in FIG. 2, elliptical vibration is also generated at the drive support section 9 of the arm 7 likewise. Namely, the arm 7 shows the behavior similar to an ultrasonic motor. In accordance with the elliptical vibration of the drive support section 9, the arm 7 is subject to a force in the right-left direction due to a frictional force between the glass surface 3 and the drive support section 9. Consequently, the blade 4 moves by itself on the glass surface 3.

A direction of the elliptical movement for the drive support section 9 determines in which direction the blade 4 moves on the glass surface 3. In FIG. 2, when the drive support section 9 vibrates clockwise viewed from the tip of the blade 4, the blade 4 moves to the right. On the contrary, when the drive support section 9 vibrates counterclockwise, the blade 4 moves to the left. Accordingly, the blade 4 can be moved reciprocally by switching between phase-A and phase-B input voltages applied to the piezoelectric elements 6a and 6b like from VA=V₀ sin ωt to V₀ cos ωt and from VB=V₀ cos ωt to V₀ sin ωt.

As mentioned above, the wiper apparatus 1 uses the blade 4 mounted with the piezoelectric elements 6a and 6b as a drive unit. The piezoelectric elements 6a and 6b apply vibration to the blade 4, allowing the blade 4 to move by itself on the glass surface 3. The wiper apparatus 1 eliminates an electromagnetic motor or a link mechanism for driving the blade, promoting a small and light-weight wiper apparatus. Since a position to mount the blade is not restricted by a motor or a link, the apparatus layout can be improved. Accordingly, the wiper apparatus can be mounted on a narrow and small place. The wiper apparatus can be attached to, e.g., a vehicle-mounted CCD camera where no wiper apparatus has been equipped due to a limited mounting area.

The example in FIG. 1 shows the configuration of attaching the piezoelectric elements 6a and 6b on the external surface of the blade 4. It may be also preferable to form the blade 4 with rubber or resin and to mold piezoelectric elements integrally therewith. It is also possible to use one piezoelectric element and drive it by means of a sawtooth voltage to be described later.

The embodiment has explained the example of arranging the rotating shaft 5 at the center of the edge on the glass surface 3 as shown in FIG. 1. Obviously, the position for arranging the blade is not limited thereto. Along with improvement of the layout, various changes and modifications may be made in the present invention with respect to the position for arranging the blade. For example, it may be preferable to arrange the rotating shaft 5 in the corner and to provide the blade 4 capable of 90 degrees of rotation for wiping as shown in FIG. 19.

(Embodiment 2)

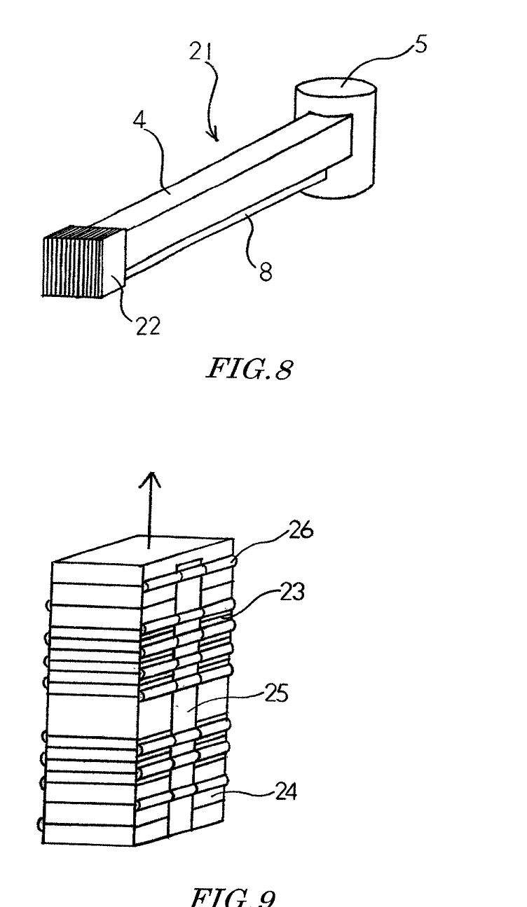

As embodiment 2 of the present invention, the following describes a hammer-shaped wiper apparatus 21 whose arm 7 is tipped with a piezoelectric element. FIG. 8 is an explanatory diagram showing a configuration of the wiper apparatus 21 as embodiment 2 of the present invention. Hereinafter, the mutually corresponding members, parts, etc. in embodiment 1 are designated by the same reference numerals and a detailed description is omitted for simplicity.

Like the apparatus in FIG. 1, the wiper apparatus 21 is also configured so that the blade 4 supported by the rotating shaft 5 can freely swing on the glass surface 3. The wiper apparatus 1 in FIG. 1 is configured so that the piezoelectric elements are integrally stuck on the blade 4. However, as shown in FIG. 8, the wiper apparatus 21 is configured so that a piezoelectric element (vibration means) 22 is attached to the tip of the arm 7.

A laminated piezoelectric ceramic is used for the piezoelectric element 22 of the wiper apparatus 21. FIG. 9 is an explanatory diagram showing a configuration of the laminated piezoelectric ceramic. As shown in FIG. 9, the laminated piezoelectric ceramic is structured by alternately layering an internal electrode 23 and a ceramic plate 24 and unifying them by adhesive, etc. Each internal electrode 23 is parallel connected every other layer by an external electrode 25. The adjacent internal electrodes 23 are separated by an insulative material 26. Applying voltage to a metal sheet causes the entire element to expand and contract in the direction of lamination.

The wiper apparatus 21 allows the arm 7 to be tipped with the piezoelectric element 22 so that the piezoelectric element is laid horizontally, i.e., the lamination is oriented along the glass surface 3. When voltage is applied to the piezoelectric element 22, it vibrates by expanding and contracting in the right-left direction. When a sawtooth voltage (to be described) is applied to the piezoelectric element 22, the blade 4 moves by itself along the glass surface 3. Thus, the wiper apparatus can be configured without using a motor or a link mechanism.

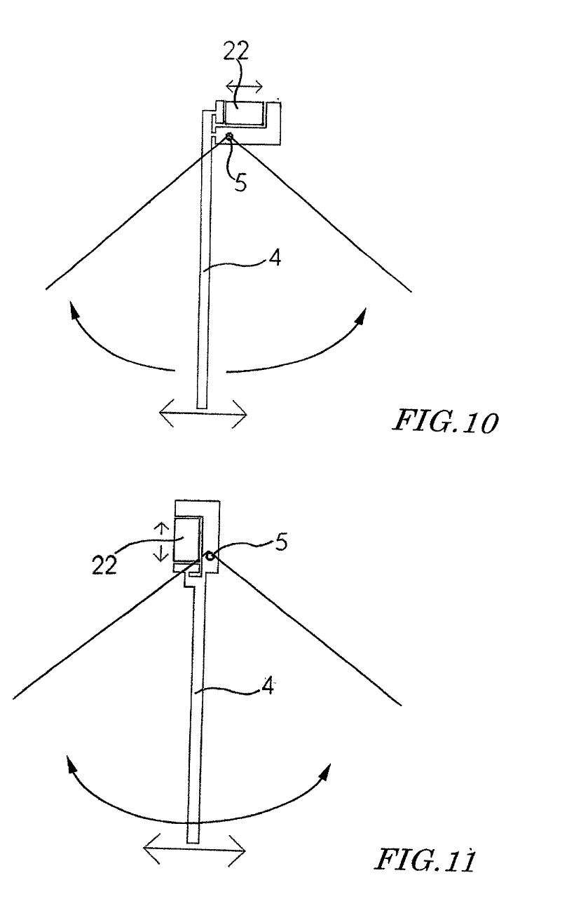

The piezoelectric element 22 can be mounted not only at the tip of the blade 4, but also in the middle or at the base thereof. FIGS. 10 and 11 are explanatory diagrams showing configurations of modification examples of arranging the piezoelectric element 22 near the rotating shaft 5. In FIG. 10, the piezoelectric element 22 is arranged so that it expands and contracts in a direction orthogonal to an extension direction of the blade 4. In FIG. 11, the piezoelectric element 22 is arranged so that it expands and contracts in a direction parallel to an extension direction of the blade 4. Pivoted by the rotating shaft 5, the piezoelectric element 22 is arranged opposite the blade 4. A displacement of the piezoelectric element 22 is magnified like a cantilever. Assuming that a lever ratio is 1:20, for example, operating the piezoelectric element for 7μ causes a 140μ displacement to the tip of the blade 4.

Arranging the piezoelectric element 22 at the tip of the blade 4 is advantageous to directly generating a torque for driving the blade. However, arranging the piezoelectric element 22 at the base of the blade 4 is advantageous to causing a large displacement due to leverage. The piezoelectric element 22 can be arranged in the middle of the blade 4. On a large wiper apparatus such as a rear wiper, etc., it is possible to arrange a plurality of piezoelectric elements 22 at a given interval in the middle of the wiper blade 4.

A circling wiper apparatus drives the blade 4 in a specified direction only. Such wiper apparatus does not need application of a sawtooth voltage and can be controlled only by a sinusoidal wave voltage. The blade 4, provided with a return spring, can be reciprocated without using a sawtooth voltage. Further, it is also possible to arrange a plurality of piezoelectric elements 22. Applying a 2-phase independent voltage there can cause the movement as described in embodiment 1 at a contact section with the glass surface.

(Embodiment 3)

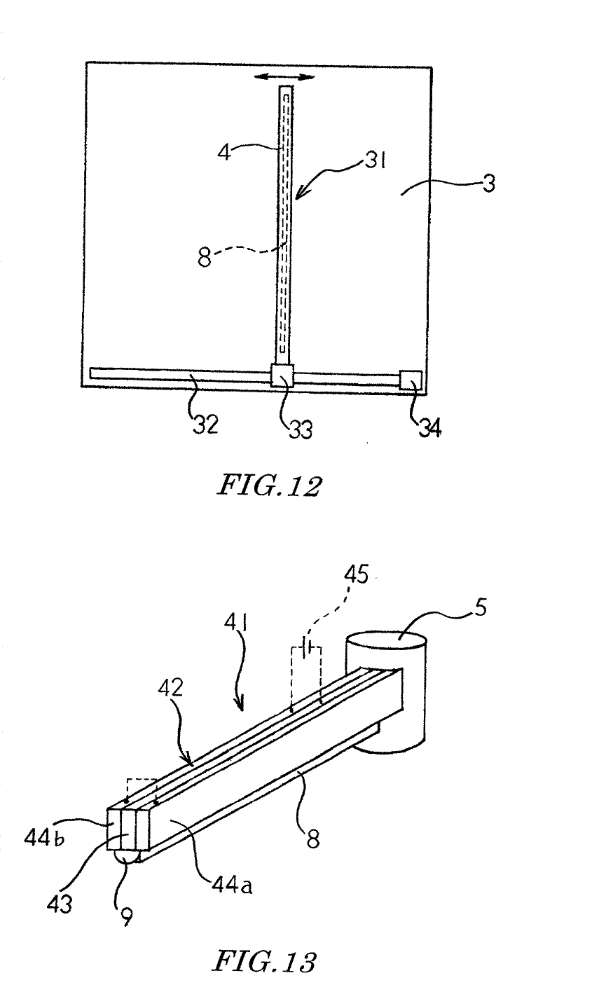

As embodiment 3, the following describes a wiper apparatus 31 provided with a guide rail for guiding the blade 4 on the glass surface 3. FIG. 12 is an explanatory diagram showing a configuration of the wiper apparatus 31 as embodiment 3 of the present invention.

As for the wiper apparatus 31, as shown in FIG. 12, the blade 4 is guided by a guide rail (guide member) 32 and moves on the glass surface 3. The guide rail 32 is provided along the edge of the glass surface 3. A slider section 33 of the blade 4 is mounted on the guide rail 32 so as to be freely movable in the right-left direction in FIG. 12. One end of the guide rail 32 is mounted with a piezoelectric element (vibration means) 34. As mentioned above, the piezoelectric element 34 comprises a piezoelectric ceramic and generates vibration in response to application of a given voltage.

The wiper apparatus 31 uses the piezoelectric element 34 to apply vibration to the guide rail 32. Vibration of the piezoelectric element 34 is transmitted to the slider section 33 via the guide rail 32, thus applying vibration to the blade 4. This vibration causes the blade 4 to move by itself on the glass surface 3 and wipe it.

A sawtooth voltage (to be described) is applied to the piezoelectric element 34, allowing the blade 4 to move by itself on the guide rail 32. The blade 4 can be driven to the right or left by changing the sawtooth voltage waveform. It maybe preferable to allow the guide rail 32 to cause surface movement forming an elliptical locus by using two piezoelectric elements 34. When two piezoelectric elements 34 are used to generate a bar traveling wave, for example, the blade 4 is driven along the guide rail 32.

The piezoelectric element 34 may be provided not only at the end of the guide rail 32, but also inside the rail. The piezoelectric element 34 can be mounted wherever vibration is applicable unless movement of the blade 4 is hindered. For example, the piezoelectric element 34 can be provided at the end of or inside the guide rail 32, but also at a position distant from the guide rail 32 via the vibration transmission means such as a lever, etc.

(Embodiment 4)

As embodiment 4, the following describes a wiper apparatus 41 having the blade 4 comprising a bimorph piezoelectric element. FIG. 13 is an explanatory diagram showing a configuration of the wiper apparatus 41 as embodiment 4 of the present invention.

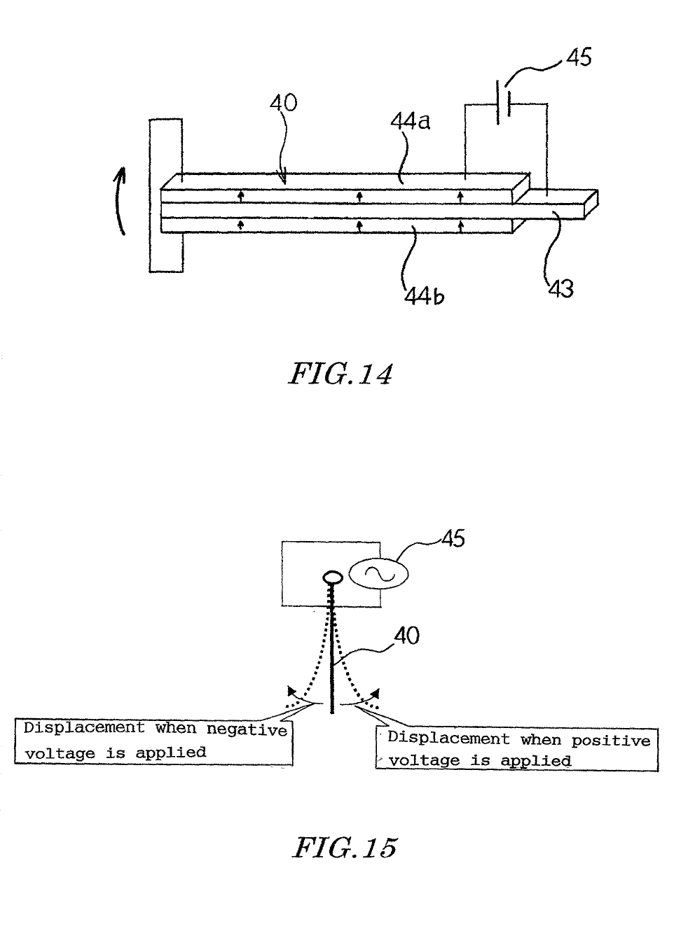

As for the wiper apparatus 41 in FIG. 13, the arm 7 in FIG. 1 is formed of a bimorph piezoelectric element (vibration means) 42. FIG. 14 is an explanatory diagram showing a general form of the bimorph piezoelectric element. FIG. 15 is an explanatory diagram showing an operation of an operation confirmation model with the bimorph piezoelectric element base fixed. As shown in FIG. 14, a bimorph piezoelectric element 40 is formed by laminating piezoelectric ceramics 44a and 44b to both sides of a shim 43 used as an electrode. The piezoelectric ceramics 44a and 44b are supplied with voltage from a power supply 45 via the shim 43. In FIG. 14, a line connecting between the piezoelectric ceramics 44a and 44b signifies electric connection therebetween.

As shown in FIG. 1, voltage is applied to the piezoelectric ceramics 44a and 44b via the shim 43. Then, the piezoelectric ceramics 44a and 44b are going to bend upward, deforming the entire piezoelectric element 40 so as to warp upward. Inverting the voltage polarity deforms the piezoelectric element 40 toward the opposite direction. As shown in FIG. 15, the model has the piezoelectric element 40 with its base fixed. Changing the polarity of the applied voltage displaces the piezoelectric element 40 right and left according to the polarity.

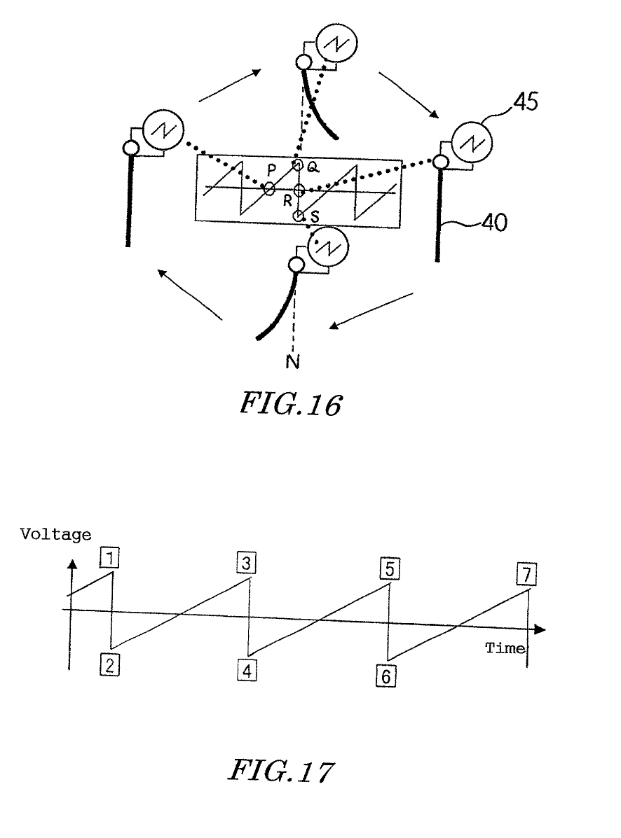

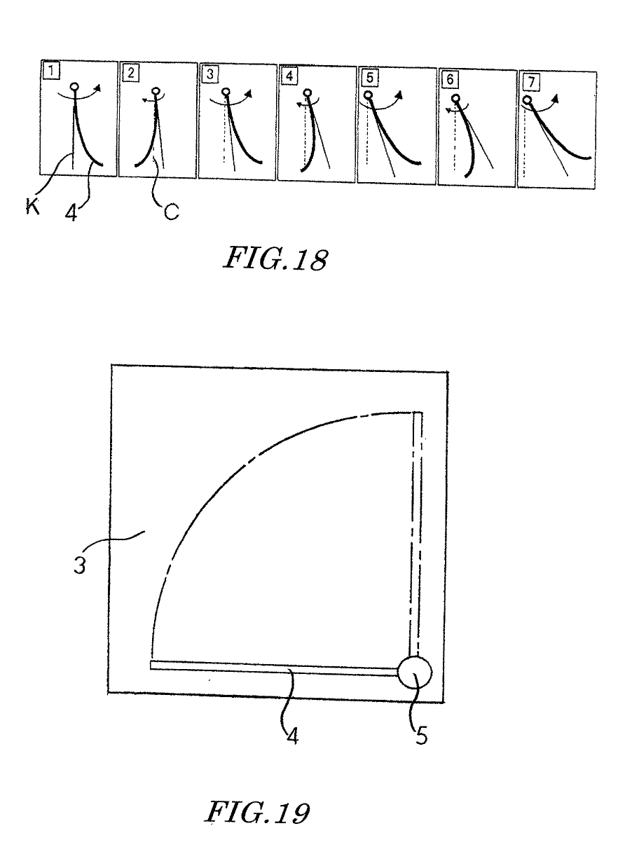

The blade 4 is formed by using such bimorph piezoelectric element. When applied with voltage having the sawtooth waveform, the blade 4 moves by itself on the glass surface 3. FIG. 16 is an explanatory diagram showing behavior of the piezoelectric element 40 when a sawtooth voltage is applied to the model in FIG. 15. FIG. 17 is an explanatory diagram showing a waveform of voltage actually applied to the wiper apparatus 41. FIG. 18 is an explanatory diagram showing behavior of the blade 4 when the voltage in FIG. 17 is applied.

Referring now to the model in FIG. 15, the following describes behavior of the piezoelectric element 40 according to the sawtooth voltage. As shown in FIG. 16, when the voltage is ±0 (P or R), the piezoelectric element 40 remains at neutral position N. When the voltage is positive (Q), however, the piezoelectric element 40 is displaced to the right of the figure. When the voltage is negative (S), the piezoelectric element 40 is displaced to the left of the figure.

Let us observe this operation with respect to the blade 4 in more detail. Since the positive voltage is applied for (1) in FIG. 17, the blade 4 is displaced to the right as shown in FIG. 18 (1). When the voltage changes from positive to negative as shown in FIG. 17 (2), the blade 4 is displaced to the left accordingly as shown in FIG. 18 (2). The voltage changes rapidly from (1) to (2) in FIG. 17. The voltage changes slowly like (1) in FIG. 17. Between these changes, there occurs a difference in the blade deformation speed. In the case of FIG. 18 (2), the blade 4 itself is greatly subject to an effect of inertia. The displacement amount for the blade 4 to the left becomes smaller than that to the right as shown in FIG. 18 (1). Accordingly, the blade 4 moves to the right in the figure for a difference between these displacement amounts. In FIG. 18, line K indicates a position for mounting the rotating shaft 5 and the blade 4. According to the change from (1) to (2) in FIG. 18, it is found that line K moves to the right along with movement of the blade 4. Dash-dot line C in FIG. 18 represents the center position of a wipe area by the blade 4.

After the applied sawtooth voltage rapidly changes from (1) to (2) in FIG. 17, the voltage gradually changes to positive from (2) to (3). In accordance with the voltage change, the blade 4 is displaced to the right as shown in FIG. 18 (3). Since the rate of voltage change is small in this case, the blade 4 is slightly subject to an effect of inertia. The blade 4 is displaced to the right for a displacement amount corresponding to the voltage. When the voltage reaches state (3) in FIG. 17, the voltage again rapidly changes to state (4). Also in this case, as mentioned above, an inertia force is generated based on a difference between speeds for deforming the blade. The displacement amount for the blade 4 to the left in FIG. 18 (4) becomes smaller than that to the right in FIG. 18 (3). Accordingly, the blade 4 moves to the right in the figure for a difference between these displacement amounts. Line K also moves to the right.

By applying the sawtooth voltage in this manner, the blade 4 gradually moves to the right (see the movement of line K) like (2), (4), and (6) in FIG. 18. The movement is caused by an effect of the inertia force based on a difference between speeds for deforming the blade. Namely, the blade repeats an operation of slowly bending and quickly returning and moves by itself to the displacement side corresponding to a slow bend. Contrary to FIG. 17, the voltage changes slowly to negative and rapidly to positive. In this case, the blade 4 moves to the left in FIG. 18. By switching voltage change patterns, the blade 4 can reciprocate on the glass surface 3. Consequently, it is possible to configure a self-propelled wiper apparatus for wiping the glass surface 3 without using a motor or a link mechanism.

The bimorph piezoelectric element can cause a large displacement with a relatively low voltage, but generates a small force. For this reason, the wiper apparatus in FIG. 13 is suitable for a CCD camera where a heavy and large obstacle such as mud, snow, etc. hardly adheres. By contrast, the wiper apparatus using an ultrasonic motor in FIG. 1 causes a small displacement amount, but can generate a large force, therefore, the wiper apparatus of this kind is suitable, e.g., for a rear wiper which requires a relatively large driving force. The displacement amount can be enlarged by increasing the frequency of applied voltage. When the frequency is approximately 20 kHz, for example, it is possible to ensure movement of approximately 50 cm/s. In addition, the laminated piezoelectric element has a relatively large size but can provide a good balance between the displacement amount and the generated force.

(Embodiment 5)

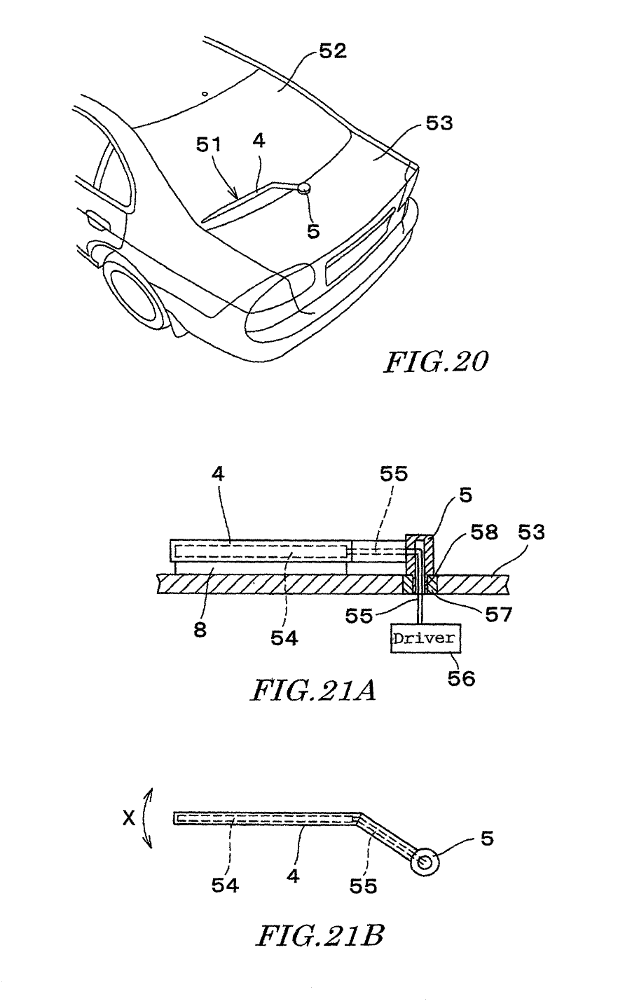

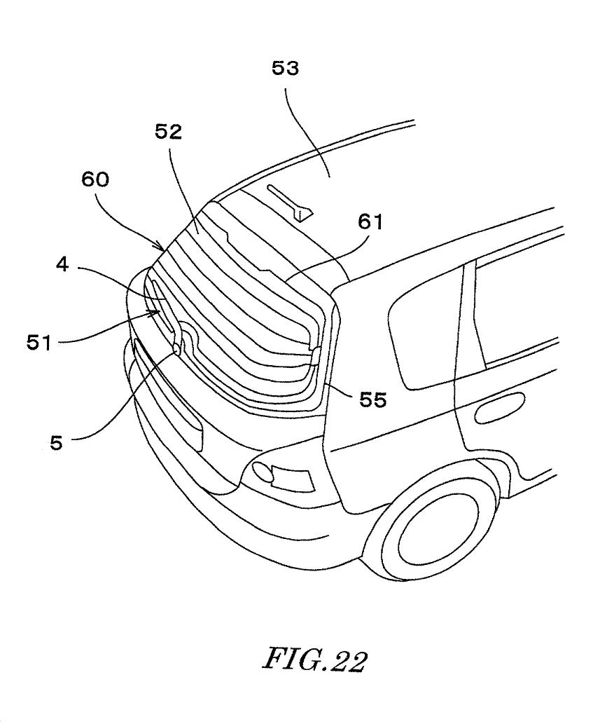

As embodiment 5, the following describes a rear wiper using a piezoelectric element. FIG. 20 is an explanatory diagram showing a state of attaching a rear wiper as embodiment 5 of the present invention. FIG. 21A, 21B is an explanatory diagram showing a configuration of the rear wiper in FIG. 20. A rear wiper 51 according to embodiment 5 uses one piezoelectric element in embodiment 1. The rear wiper 51 swings the blade 4 right and left by applying the sawtooth voltage as described in embodiment 4 to the piezoelectric element.

As shown in FIG. 20, the rear wiper 51 uses the blade 4 approximately 500 mm long arranged on a car rear window 52. The blade 4 is fixed to the rotating shaft 5 attached to the car body 53 and is swingably provided on the rear window 52 around the rotating shaft 5. The wipe rubber 8 is attached under the blade 4 as shown in FIG. 21A.

As shown in FIG. 21A, 21B, there is provided a flat bimorph piezoelectric element 54 (hereafter abbreviated as a piezoelectric element 54) inside the blade 4. A lead wire 55 is attached to the piezoelectric element 54. As shown in FIG. 21B, the lead wire 55 is connected to a driver 56 through the space inside the hollow rotating shaft 5.

The rotating shaft 5 is rotatably supported by a bearing 57 attached to the car body 53. A small-diameter section 58 of the rotating shaft 5 is slightly pressed into the bearing 57. The bearing 57 supplies the rotating shaft 5 with rotational resistance acting in a direction for restricting the revolution. A driver 56 applies a sawtooth voltage as shown in FIG. 17. The entire piezoelectric element 54 bends on the basis of the rotating shaft 5. The tip of the blade 4 operates toward direction X in FIG. 21B. The blade rotates around the rotating shaft 5 similarly to FIG. 18.

In this case, the rotational resistance applied to the rotating shaft 5 acts on an inertial force which is generated based on a difference between speeds for deforming the blade. As the blade 4 deforms, the inertia force and the frictional force are opposed to each other. A relevant actuator is so configured that the rotational resistance becomes greater than the inertia force toward (1) in FIG. 17 and becomes smaller than the inertia force for transition from (1) to (2) in FIG. 17. Accordingly, the inertia force toward (1) is nullified by the rotational resistance. The blade 4 is slowly displaced for an angle corresponding to the voltage value. On the contrary, during the transition from (1) to (2), the inertia force is not nullified by the rotational resistance. The blade 4 is rapidly displaced toward the opposite direction so as not to compensate the angle corresponding to the voltage value. The blade 4 does not return fully. During the transition from (1) to (2), the blade 4 is greatly subject to its inertia. The displacement amount of the blade 4 becomes smaller than that for the transition to (1). Therefore, the blade 4 moves for a difference between these displacement amounts.

The sawtooth voltage applied rapidly changes during the transition from (1) to (2), and then gradually changes to positive during the transition from (2) to (3). The blade 4 is displaced in accordance with voltage changes. Since the rate of voltage change is small in this case, the blade 4 is slightly subject to an effect of inertia. The blade 4 is displaced for a displacement amount corresponding to the voltage. When the voltage reaches state (3), the voltage again rapidly changes to state (4). Also in this case, as mentioned above, an inertia force is generated based on a difference between speeds for deforming the blade 4. The displacement amount for the blade 4 for the transition from (3) to (4) becomes smaller than that for the transition from (2) to (3). Accordingly, the blade 4 moves for a difference between these displacement amounts.

By applying the sawtooth voltage in this manner, the blade 4 gradually moves in a given direction due to an effect of the inertia force based on a difference between, deformation speeds of the piezoelectric element 54. The blade 4 thus rotatively moves around the rotating shaft 5. Namely, the blade 4 repeats an operation of slowly bending and quickly returning and moves by itself to the displacement side corresponding to a slow bend. Contrary to FIG. 17, the voltage changes slowly to negative and rapidly to positive. In this case, the blade 4 rotates reversely. By switching voltage change patterns, the blade 4 can reciprocate properly. Consequently, it is possible to configure the rear wiper 51 which swings without using a motor or a link mechanism.

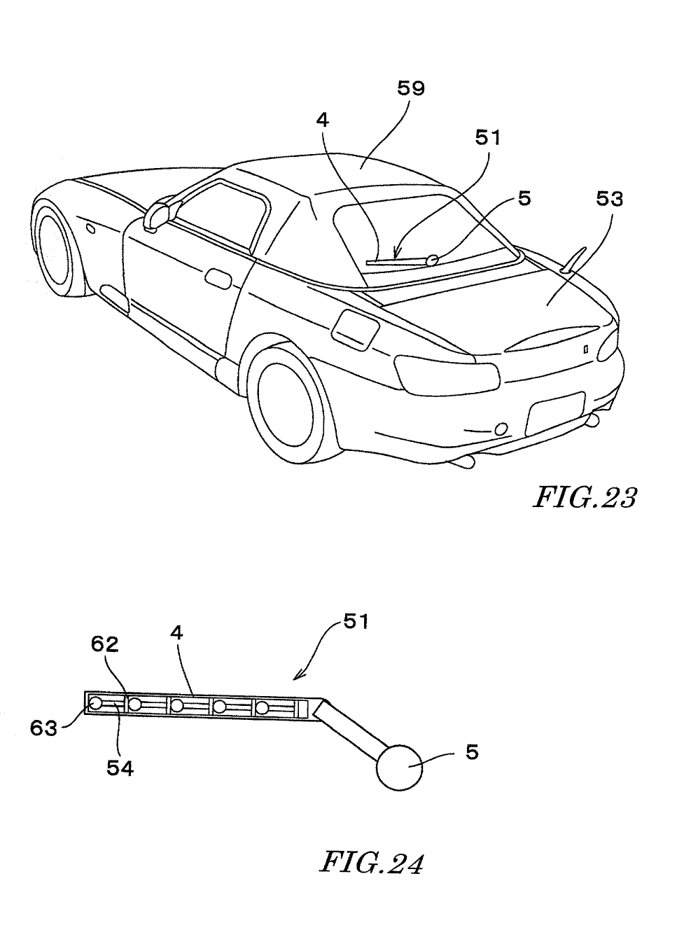

The rear wiper 51 can rotatively move the blade 4 by using a simple configuration. The rear wiper 51 eliminates an electromagnetic motor or a link mechanism for driving the blade 4. Since a position to mount the rear wiper is not restricted by a motor or a link, the apparatus layout can be improved. Namely, the entire wiper apparatus body can be arranged on the rear window 52. It is just necessary to arrange only the lead wire 55 and the driver 56 in the body 53. Accordingly, the rear wiper can be mounted on a narrow and small place. For example, the rear wiper 51 can be mounted on a glass hatch 60 of a hatchback car as shown in FIG. 22 and on the rear window 52 of a convertible having a retractable fabric top 59 as shown in FIG. 23. Since the piezoelectric element 54 is controlled at a high voltage, the lead wire 55 can be thinned accordingly. As shown in FIG. 22, the lead wire 55 can be replaced by printed wiring like a defroster 61 on the rear window 52.

The rear wiper 51 can be freely controlled for an intermittent operation, variable speed, reverse operation, etc. by changing the voltage input waveform. The intermittent operation can be controlled by adjusting a sawtooth interval. The speed can be controlled by adjusting the sawtooth frequency. The forward reverse control can be facilitated by switching voltage change patterns. Accordingly, a forward reverse circuit, a relay plate, etc. are unneeded, simplifying the circuit configuration or other configurations near the motor.

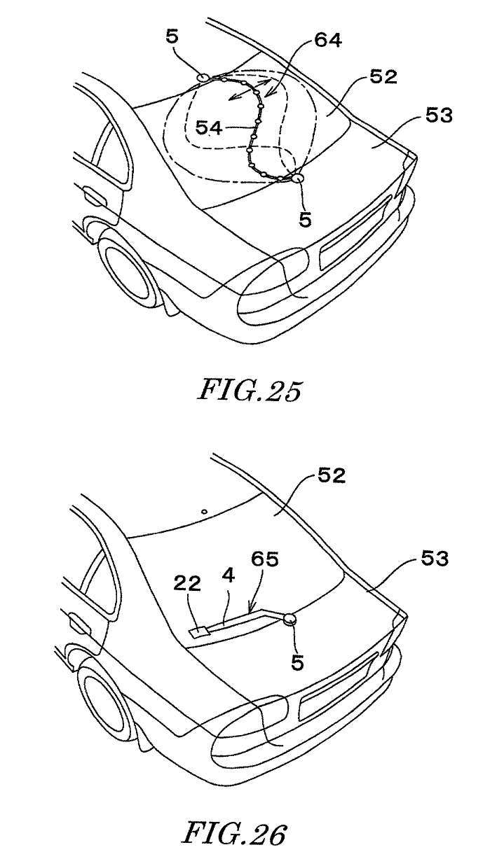

While there has been described the rear wiper 51 using one piezoelectric element 54, it may be preferable to serially connect a plurality of piezoelectric elements approximately 20 to 100 mm long as shown in FIG. 24, for example. In this case, one end of the piezoelectric element 54 is fixed to a fixing section 62. The other end is provided with a weight 63 for increasing inertia. It is possible to configure a rear wiper 64 as shown in FIG. 25 by serially connecting a plurality of piezoelectric elements 54. The rear wiper 64 serpentines on the rear window 52 for wiping within an elliptic area.

(Embodiment 6)

As embodiment 6, the following describes an example of applying the wiper apparatus according to embodiment 2 to a rear wiper. FIG. 26 is its explanatory diagram. In a rear wiper 65, the blade 4 is tipped with the piezoelectric element 22. A laminated piezoelectric ceramic is used for the piezoelectric element 22. The piezoelectric element 22 is attached to the tip of the blade 4 so that the lamination direction follows the rear window 52. When applied with voltage, the piezoelectric element 22 expands and contracts in the right-left direction. When a sawtooth voltage is applied further, the blade 4 moves by itself along the rear window 52. Consequently, it is possible to configure the rear wiper without using a motor or a link mechanism.

(Embodiment 7)

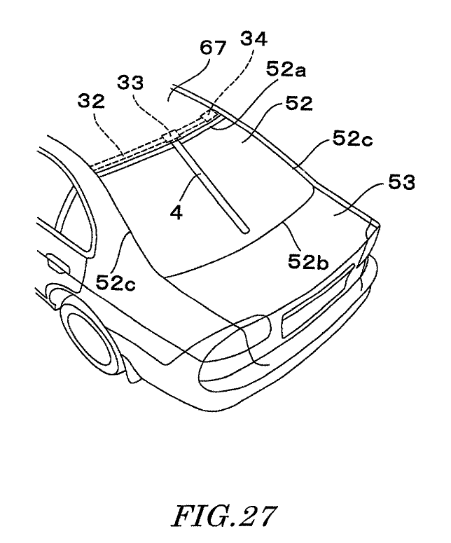

As embodiment 7, the following describes an example of applying the wiper apparatus according to embodiment 3 to a rear wiper. FIG. 27 is its explanatory diagram. A rear wiper 66 is provided with the guide rail 32 at the end of a rooftop 67 on the car body 53 along an upper edge 52a of the rear window 52. The slider section 33 of the blade 4 is freely movably mounted on the guide rail 32 in the car width direction. The piezoelectric element 34 is attached at one end of the guide rail 32.

The piezoelectric element 34 applies vibration to the guide rail 32. The guide rail 32 transmits vibration to the blade 4 via the slider section 33. This vibration allows the blade 4 to move by itself on the rear window 52. Also in this case, a sawtooth voltage is applied to the piezoelectric element 34 as mentioned above. Changing the waveform enables to control operational directions, speeds, etc. of the blade 4. While FIG. 27 shows the example of providing the guide rail 32 along the upper edge 52a of the rear window 52, the guide rail 32 may be provided along a lower edge 52b or a side edge 52c. When the guide rail 32 is provided along the side edge 52c, a pair of blades 4 can be arranged right and left.

The present invention is not limited to the above-mentioned embodiments. It is further understood by those skilled in the art that various changes and modifications may be made in the present invention without departing from the spirit and scope thereof.

While the above-mentioned embodiments have explained the examples of applying the wiper apparatus according to the present invention to a car, the present invention is not limited thereto. The wiper apparatus can be mounted on not only on-vehicle equipment, but also an outdoor surveillance camera, for example. The wiper apparatus can be mounted on a small surveillance camera where no wiper apparatus has been equipped conventionally. A small and light-weight apparatus is available by substituting the wiper apparatus according to the present invention for the wiper system using an electromagnetic motor which has been conventionally mounted on a large camera, etc.

While embodiments 5 through 7 have explained the examples of applying the wiper apparatuses according to embodiments 1 through 3 to a car rear wiper, the wiper apparatus according to embodiment 4 can be also applied to the rear wiper. In this case, the apparatus in FIG. 13 can be scaled up. It is also possible to form a long blade by serially connecting a plurality of short blades, e.g., 20 through 100 mm long.

As mentioned above, the wiper apparatus according to the present invention can allow the wiper blade to move by itself on the wipe surface by applying vibration to the wiper blade through the use of the vibration means such as a piezoelectric ceramic, etc. There is no need for an electromagnetic motor or a link mechanism to drive the wiper blade, enabling the wiper apparatus to be small and light-weight. Since a position to mount the wiper blade is not restricted by a motor or a link, the apparatus layout can be improved. Accordingly, the wiper apparatus can be mounted on a narrow and small place. The wiper apparatus can be attached to, e.g., a vehicle-mounted CCD camera where no wiper apparatus has been equipped due to a limited mounting area.

Further, the wiper apparatus according to the present invention uses the vibration means to configure the wiper blade itself, making it possible to simplify the apparatus configuration and decrease the apparatus weight. There is no need for an electromagnetic motor or a link mechanism to drive the wiper blade, enabling the wiper apparatus to be small and light-weight and improving the layout.

Moreover, the car rear wiper according to the present invention uses the piezoelectric element to supply the wiper blade arranged on the rear window with reciprocal vibration along the movement direction. The wiper blade can move by itself on the rear window. There is no need for an electromagnetic motor or a link mechanism to drive the wiper blade, enabling the wiper apparatus to be small and light-weight. Since a position to mount the wiper blade is not restricted by a motor or a link, the apparatus layout can be improved. Accordingly, the rear wiper can be mounted on a hatchback car's glass hatch, a convertible's rear window, etc. The rear wiper can be freely controlled for an intermittent operation, variable speed, reverse operation, etc. by changing the voltage input waveform. Accordingly, a forward reverse circuit, a relay plate, etc. are unneeded, simplifying the circuit configuration or other configurations near the motor.

What is claimed is:

1. A wiper apparatus comprising:
a wiper blade which is mounted on a wipe surface and is movably provided along said wipe surface; and
a vibration means which provides said wiper blade with vibration for driving said wiper blade on said wipe surface.

2. The wiper apparatus according to claim 1, wherein said vibration means is provided on said wiper blade.

3. The wiper apparatus according to claim 1, where in said vibration means is provided inside said wiper blade.

4. The wiper apparatus according to claim 1, wherein a plurality of said wiper blades is connected in series.

5. The wiper apparatus according to claim 1, wherein
said wiper blade has one end fixed to a rotating shaft and is swingably provided on said wipe surface; and
said vibration means is provided at a tip of the other end of said wiper blade.

6. The wiper apparatus according to claim 1, wherein
said wiper blade has one end fixed to a rotating shaft and is swingably provided on said wipe surface; and
said vibration means is provided near said rotating shaft.

7. The wiper apparatus according to claim 1, wherein
said wiper blade has one end fixed to a rotating shaft and is swingably provided on said wipe surface; and
there is provided a plurality of said vibration means at a given interval on said wiper blade.

8. The wiper apparatus according to claim 1, wherein
said wiper blade is guided by a guide member provided along said wipe surface; and
said vibration means applies vibration to said guide member.

9. A wiper apparatus which drives a wiper blade provided on a wipe surface along said wipe surface; wherein
said wiper blade comprises a vibration means; and
said vibration means generates vibration to allow said wiper blade to move by itself on said wipe surface.

10. The wiper apparatus according to any of claims 1 through 9, wherein
said vibration means comprises a piezoelectric element.

11. The wiper apparatus according to claim 10, wherein
said piezoelectric element is supplied with voltage having a sinusoidal waveform.

12. The wiper apparatus according to claim 11, wherein
said vibration means generates elliptical vibration for a drive support section formed at a contact section between said wiper blade and said wipe surface, and uses the elliptical vibration to drive said wiper blade on said wipe surface.

13. The wiper apparatus according to claim 10, wherein
said piezoelectric element is applied with voltage having a sawtooth waveform.

14. The wiper apparatus according to claim 13, wherein
said sawtooth voltage causes a difference in deformation speeds of said piezoelectric element;
the deformation speed difference causes a difference in inertia forces acting on said wiper blade;
the displacement amount for a slow change in said sawtooth voltage becomes greater than that for a rapid change therein; and
said wiper blade moves toward a side of said greater displacement amount.

15. A car rear wiper comprising:
a wiper blade which is arranged on a car rear window and is swingably provided on said rear window with one end fixed to a rotating shaft; and
a piezoelectric element which is attached to said wiper blade and applies reciprocal vibration to said wiper blade along its movement direction.

16. The car rear wiper according to claim 15, wherein
said car rear wiper further comprises a resistance provision means for applying rotational resistance to said rotating shaft.

17. The car rear wiper according to claim 15, wherein
there is a plurality of said piezoelectric elements serially connected to said wiper blade.

18. The car rear wiper according to claim 15, wherein
said piezoelectric element is provided to the tip of the other end of said wiper blade.

19. The car rear wiper according to claim 15, wherein
said piezoelectric element is applied with voltage having a sawtooth waveform.

20. The car rear wiper according to claim 19, wherein
said sawtooth voltage causes a difference in deformation speeds of said piezoelectric element;
the deformation speed difference causes a difference in inertia forces acting on said wiper blade;
the displacement amount for a slow change in said sawtooth voltage becomes greater than that for a rapid change therein; and
said wiper blade moves toward a side of said greater displacement amount.

21. A car rear wiper comprising:
a guide rail provided along an edge of a car rear window;
a wiper blade which is attached to said guide rail and is movable along said guide rail; and
a piezoelectric element which is attached to said guide rail and supplies said wiper blade with reciprocal vibration along its movement direction via said guide rail.
